(19) United States
(12) Patent Application Publication
(10) Pub. No.: US 2023/0103342 A1
(43) Pub. Date: Apr. 6, 2023

(54) CURING AGENTS FOR EPOXY RESIN COATINGS

(71) Applicant: SIKA TECHNOLOGY AG, Baar (CH)

(72) Inventors: Edis KASEMI, Zürich (CH); Oguz SARIOGLU, Heilbronn (DE); Urs BURCKHARDT, Zürich (CH); Andreas KRAMER, Zürich (CH); Ursula STADELMANN, Zürich (CH); Jochen GRÖTZINGER, Schwäbisch Gmünd (DE); Uwe VON DER BRÜGGEN, Meckesheim (DE)

(73) Assignee: SIKA TECHNOLOGY AG, Baar (CH)

(21) Appl. No.: 17/794,164

(22) PCT Filed: Feb. 22, 2021
(86) PCT No.: PCT/EP2021/054254

§ 371 Date: Jul. 20, 2022

(30) Foreign Application Priority Data
Feb. 24, 2020 (EP) 20158940.5

(51) Int. Cl. C08G 59/18; C09D 163/00; C08G 59/46; C08G 59/50

(52) U.S. Cl. CPC C08G 59/184; C09D 163/00; C08G 59/46; C08G 59/5033; C08G 59/5026

(57) ABSTRACT

A curing agent for epoxy resins, including 1-amino-3-aminomethyl-3,5,5-trimethylcyclohexane and N-benzyl-1,2-ethandiamine in an amount for the ratio of the number of its amine hydrogens to be in the range of 90/10 to 20/80. The curing agent permits suitable epoxy resin compositions that have excellent workability and that cure particularly rapidly in cold and damp conditions, without blushing-induced surface defects, thus achieving coatings of in particular high hardness, high glass transition temperature and surprisingly little tendency to yellowing.

### TECHNICAL FIELD

The invention relates to curing agents for epoxy resin compositions that are particularly suitable as a coating, especially for floors.

### STATE OF THE ART

Coatings based on epoxy resins are widely used in the building trade. They consist of liquid resin and curing agent components, which are mixed before application and cure at ambient temperatures within a range from about 5 to 35° C. When applied, the viscosity of the coatings should be as low as possible so that they flow well at ambient temperature. After application, they should cure as quickly as possible and without problems, even under damp and cold conditions, and form a defect-free surface without haze, spots, tack or craters. Once cured, they should have high hardness coupled with low brittleness and a high glass transition temperature in order to withstand mechanical stress as well as possible. For visually demanding applications, for example top coverings of floors, they should additionally have a high level of gloss and a minimal tendency to yellowing under the influence of light.

However, such epoxy resin coatings often have a tendency to surface defects such as haze, spots, roughness or tack, which is also referred to as “blushing”. Blushing is caused by the amines present in the curing agent component forming a salt with carbon dioxide from the air and occurs particularly at high humidity and low temperatures. Many curing agents for epoxy resin coatings comprise adducts of diamines with epoxy resin. This reduces blushing effects and also permits more rapid curing. However, diamine-epoxy resin adducts are significantly more viscous than the free diamines, which means that such curing agents often contain significant amounts of thinners and/or can be filled only moderately with inorganic fillers. Thinners are not incorporated into the resin matrix during curing and may be released into the environment through evaporation or diffusion processes. Nowadays, there is however an increasing desire for low-emission products that after curing have a low content of releasable substances. For low-emission or emission-free epoxy resin compositions, thinners of this kind can therefore be used only in small amounts or not at all.

EP 3 344 677 discloses epoxy resin compositions that comprise N-benzylethane-1,2-diamine in the curing agent and permit coatings having nice surfaces. The coatings comprise either diamine-epoxy resin adducts, which greatly increase their viscosity, or polyoxypropylene diamines, which result in their having an undesirably low glass transition temperature.

### SUMMARY OF THE INVENTION

The object of the present invention is therefore to provide a curing agent for epoxy resins that with little or no thinner permits very-low viscosity, easily processable epoxy resin compositions having rapid curing, high final hardness, and a high glass transition temperature, and is suitable for coatings that result in defect-free, glossy surfaces even under damp and cold ambient temperatures.

This object is achieved by a curing agent as described in claim 1. The curing agent comprises 1-amino-3-aminomethyl-3,5,5-trimethylcyclohexane (IPDA) and N-benzylethane-1,2-diamine in such an amount that the ratio of the number of amine hydrogens therein is within a range from 70/30 to 20/80. In the ratio according to the invention, the curing agent permits an advantageous combination of high glass transition temperature, high final hardness, nice surface, and rapid curing under cold conditions. A higher content of IPDA results in slow curing, an undesirably dull surface under cold conditions, and an increased tendency to yellowing, and a higher content of N-benzylethane-1,2-diamine results in an undesirably low glass transition temperature and final hardness.

Surprisingly, coatings comprising the curing agent of the invention show a particularly low tendency to yellowing under the influence of light.

The curing agent of the invention permits epoxy resin compositions suitable as a coating that have excellent processability and rapid curing and that have little tendency to blushing-related defects even under damp and cold conditions and that, after curing, have high hardness, a high glass transition temperature, and a surprisingly low tendency to yellowing.

Further aspects of the invention are the subject of further independent claims. Particularly preferred embodiments of the invention are the subject of the dependent claims.

### WAYS OF EXECUTING THE INVENTION

The invention provides a curing agent for epoxy resins, comprising 1-amino-3-aminomethyl-3,5,5-trimethylcyclohexane (IPDA) in free form and/or adducted with epoxy resin and N-benzylethane-1,2-diamine in such an amount that the ratio of the number of amine hydrogens therein is within a range from 90/10 to 20/80.

A “primary amino group” refers to an amino group that is attached to a single organic radical and bears two hydrogen atoms; a “secondary amino group” refers to an amino group that is attached to two organic radicals that may also together be part of a ring and bears one hydrogen atom; and a “tertiary amino group” refers to an amino group that is attached to three organic radicals, two or three of which may also be part of one or more rings, and does not bear any hydrogen atom. “Amine hydrogen” refers to the hydrogen atoms of primary and secondary amino groups.

“Amine hydrogen equivalent weight” refers to the mass of an amine or an amine-containing composition that contains one molar equivalent of amine hydrogen. It is expressed in units of “g/equiv.”.

“Epoxide equivalent weight” refers to the mass of an epoxy group-containing compound or composition that contains one molar equivalent of epoxy groups. It is expressed in units of “g/equiv.”.

Substance names beginning with “poly”, such as polyamine or polyepoxide, refer to substances that formally contain two or more of the functional groups that occur in their name per molecule.

A “thinner” refers to a substance that is soluble in an epoxy resin and lowers its viscosity, and that is not chemically incorporated into the epoxy resin polymer during the curing process.

“Molecular weight” refers to the molar mass (in grams per mole) of a molecule.

“Average molecular weight” refers to the number-average molecular weight Mₙ of a polydisperse mixture of oligomeric or polymeric molecules, which is typically determined by gel-permeation chromatography (GPC) against polystyrene as standard.

The “gel time” is the time interval from mixing the components of an epoxy resin composition until the gelation thereof.

“Room temperature” refers to a temperature of 23° C.

The IPDA present in the curing agent is preferably used in a commercially available quality, for example in the form of Vestamin® IPD (from Evonik) or Baxxodur® EC 201 (from BASF).

The IPDA present in the curing agent is preferably in free form, not adducted with epoxy resin. The curing agent preferably contains less than 10% by weight, more preferably less than 5% by weight, in particular less than 1% by weight, of IPDA adducted with epoxy resin. Most preferably, the curing agent is free of IPDA adducted with epoxy resin. Such a curing agent is of particularly low viscosity.

The N-benzylethane-1,2-diamine present in the curing agent preferably has a purity of at least 80% by weight, more preferably at least 90% by weight, in particular at least 95% by weight. N,N′-Dibenzylethane-1,2-diamine is optionally additionally present. Preferably less than 2% by weight, in particular less than 1% by weight, of ethane-1,2-diamine is present.

The N-benzylethane-1,2-diamine present in the curing agent is preferably in free form, not adducted with epoxy resin. The curing agent preferably contains less than 10% by weight, more preferably less than 5% by weight, in particular less than 1% by weight, of N-benzylethane-1,2-diamine adducted with epoxy resin. Most preferably, the curing agent is free of N-benzylethane-1,2-diamine adducted with epoxy resin. Such a curing agent is of particularly low viscosity.

N-Benzylethane-1,2-diamine is preferably produced by partial alkylation of ethane-1,2-diamine with at least one benzylating agent.

The alkylation is preferably a reductive alkylation using benzaldehyde as the benzylating agent and hydrogen.

Preference is given to carrying out the reductive alkylation in the presence of a suitable catalyst. Preferred catalysts are palladium on charcoal (Pd/C), platinum on charcoal (Pt/C), Adams' catalyst or Raney nickel, especially palladium on charcoal or Raney nickel.

When molecular hydrogen is used, the reductive alkylation is preferably operated in a pressure apparatus at a hydrogen pressure of 5 to 150 bar, especially 10 to 100 bar. This can take place in a batchwise process or preferably in a continuous process.

The reductive alkylation is preferably carried out at a temperature within a range from 40 to 120° C., in particular 60 to 100° C.

Preferably, ethane-1,2-diamine is used in a stoichiometric excess relative to benzaldehyde and, after the alkylation, some or all of the unreacted ethane-1,2-diamine is removed from the reaction mixture, in particular by stripping.

If desired, the reaction mixture may then be purified further, more particularly by removing by distillation at least some of the N,N′-dibenzylethane-1,2-diamine from the N-benzylethane-1,2-diamine that is obtained. This permits curing agents having particularly high reactivity and epoxy resin compositions having a particularly high glass transition temperature.

The ratio of the number of amine hydrogens from IPDA and N-benzylethane-1,2-diamine is preferably within a range from 80/20 to 25/75, in particular 75/25 to 30/70. Such a curing agent permits epoxy resin compositions having a particularly good combination of rapid curing, high hardness, high glass transition temperature, and a nice surface.

The ratio of the number of amine hydrogens from IPDA and N-benzylethane-1,2-diamine is particularly preferably within a range from 80/20 to 30/70, in particular 70/30 to 50/50. Such a curing agent permits a particularly high glass transition temperature alongside a nice surface.

Particular preference is further given to a ratio of the number of amine hydrogens from IPDA and N-benzylethane-1,2-diamine within a range from 70/30 to 20/80.

Such a curing agent permits particularly rapid curing under cold conditions within 24 hours.

The curing agent of the invention preferably comprises at least one further constituent selected from the group consisting of further amines, accelerators, and thinners.

Suitable further amines are especially N-benzylpropane-1,2-diamine, N-benzyl-1,3-bis(aminomethyl)benzene, N-(2-ethylhexyl)-1,3-bis(aminomethyl)benzene or N-(2-phenylethyl)-1,3-bis(aminomethyl)benzene, 2,2-dimethylpropane-1,3-diamine, pentane-1,3-diamine (DAMP), pentane-1,5-diamine, 1,5-diamino-2-methylpentane (MPMD), 2-butyl-2-ethylpentane-1,5-diamine (C11-neodiamine), hexane-1,6-diamine, 2,5-dimethylhexane-1,6-diamine, 2,2(4),4-trimethylhexane-1,6-diamine (TMD), heptane-1,7-diamine, octane-1,8-diamine, nonane-1,9-diamine, decane-1,10-diamine, undecane-1,11-diamine, dodecane-1,12-diamine, 1,2-, 1,3- or 1,4-diaminocyclohexane, 1,3-bis(aminomethyl)cyclohexane, 1,4-bis(aminomethyl)cyclohexane, bis(4-aminocyclohexyl)methane, bis(4-amino-3-methylcyclohexyl)methane, bis(4-amino-3-ethylcyclohexyl)methane, bis(4-amino-3,5-dimethylcyclohexyl)methane, bis(4-amino-3-ethyl-5-methylcyclohexyl)methane, 2(4)-methyl-1,3-diaminocyclohexane, 2,5(2,6)-bis(aminomethyl)bicyclo[2.2.1]heptane (NBDA), 3(4),8(9)-bis(aminomethyl)tricyclo[5.2.1.0^{2.6}]decane, 1,4-diamino-2,2,6-trimethylcyclohexane (TMCDA), menthane-1,8-diamine, 3,9-bis(3-aminopropyl)-2,4,8,10-tetraoxaspiro[5.5]undecane, 1,3-bis(aminomethyl)benzene (MXDA), 1,4-bis(aminomethyl)benzene, bis(2-aminoethyl) ether, 3,6-dioxaoctane-1,8-diamine, 4,7-dioxadecane-1,10-diamine, 4,7-dioxadecane-2,9-diamine, 4,9-dioxadodecane-1,12-diamine, 5,8-dioxadodecane-3,10-diamine, 4,7,10-trioxatridecane-1,13-diamine or higher oligomers of these diamines, bis(3-aminopropyl)polytetrahydrofurans or other polytetrahydrofurandiamines, polyoxyalkylene diamines or triamines, especially polyoxypropylene diamines or polyoxypropylene triamines such as Jeffamine® D-230, Jeffamine® D-400 or Jeffamine® T-403 (all from Huntsman), diethylene triamine (DETA), triethylene tetramine (TETA), tetraethylene pentamine (TEPA), pentaethylene hexamine (PEHA), dipropylene triamine (DPTA), N-(2-aminoethyl)propane-1,3-diamine (N3-amine), N,N′-bis(3-aminopropyl)ethylenediamine (N4-amine), N,N′-bis(3-aminopropyl)-1,4-diaminobutane, N5-(3-aminopropyl)-2-methylpentane-1,5-diamine, N3-(3-aminopentyl)pentane-1,3-diamine, N5-(3-amino-1-ethylpropyl)-2-methylpentane-1,5-diamine, N,N′-bis(3-amino-1-ethylpropyl)-2-methylpentane-1,5-diamine, 3-(2-aminoethyl)aminopropylamine, bis(hexamethylene)triamine (BHMT), N-aminoethylpiperazine, 3-dimethylaminopropylamine (DMAPA) or 3-(3-(dimethylamino)propylamino)propylamine (DMAPAPA), and also further adducts of these polyamines with epoxy resins or monoepoxides, or adducts of ethane-1,2-diamine or propane-1,2-diamine with epoxy resins or monoepoxides and subsequent removal of excess ethane-1,2-diamine or propane-1,2-diamine by distillation.

It may be advantageous when the curing agent of the invention comprises a combination of two or more further amines.

Preference is given to further amines selected from the group consisting of TMD, 1,2-diaminocyclohexane, 1,3-diaminocyclohexane, 1,4-diaminocyclohexane, 1,3-bis(aminomethyl)cyclohexane, 1,4-bis(aminomethyl)cyclohexane, bis(4-aminocyclohexyl)methane, 2(4)-methyl-1,3-diaminocyclohexane, MXDA, polyoxypropylene diamines having an average molecular weight Mₙ within a range from 200 to 500 g/mol, polyoxypropylene triamines having an average molecular weight Mₙ within a range from 300 to 500 g/mol, DMAPAPA, BHMT, DETA, TETA, TEPA, PEHA, DPTA, N3-amine, N4-amine, adducts of MXDA, DETA, TETA or TEPA with epoxy resins, and adducts of MPMD, ethane-1,2-diamine or propane-1,2-diamine with cresyl glycidyl ether, in which unreacted MPMD, ethane-1,2-diamine or propane-1,2-diamine were removed by distillation after the reaction.

Preference among these is given to 1,2-diaminocyclohexane, 1,3-bis(aminomethyl)cyclohexane, 1,4-bis(aminomethyl)cyclohexane, 2(4)-methyl-1,3-diaminocyclohexane, MXDA, polyoxypropylene diamines having an average molecular weight Mₙ within a range from 200 to 500 g/mol, and polyoxypropylene triamines having an average molecular weight Mₙ within a range from 300 to 500 g/mol.

Particular preference is given to 1,3-bis(aminomethyl)cyclohexane or MXDA, especially 1,3-bis(aminomethyl)cyclohexane. These amines permit particularly rapid curing.

Particular preference is further given to polyoxypropylene diamines or polyoxypropylene triamines. These permit particularly low brittleness.

Suitable accelerators are especially acids or compounds hydrolyzable to acids, especially organic carboxylic acids such as acetic acid, benzoic acid, salicylic acid, 2-nitrobenzoic acid, lactic acid, organic sulfonic acids such as methanesulfonic acid, p-toluenesulfonic acid or 4-dodecylbenzenesulfonic acid, sulfonic esters, other organic or inorganic acids, such as phosphoric acid in particular, or mixtures of the abovementioned acids and acid esters; nitrates such as calcium nitrate in particular; tertiary amines such as in particular 1,4-diazabicyclo[2.2.2]octane, benzyldimethylamine, α-methylbenzyldimethylamine, triethanolamine, dimethylaminopropylamine, imidazoles such as in particular N-methylimidazole, N-vinylimidazole or 1,2-dimethylimidazole, salts of such tertiary amines, quaternary ammonium salts, such as benzyltrimethylammonium chloride in particular, amidines, such as 1,8-diazabicyclo[5.4.0]undec-7-ene in particular, guanidines, such as 1,1,3,3-tetramethylguanidine in particular, phenols, especially bisphenols, phenolic resins or Mannich bases such as in particular 2-(dimethylaminomethyl)phenol, 2,4,6-tris(dimethylaminomethyl)phenol or polymers produced from phenol, formaldehyde and N,N-dimethylpropane-1,3-diamine, phosphites such as in particular di- or triphenyl phosphites, or compounds having mercapto groups. Preference is given to acids, nitrates, tertiary amines or Mannich bases, especially salicylic acid, calcium nitrate or 2,4,6-tris(dimethylaminomethyl)phenol, or a combination of these accelerators.

The curing agent particularly preferably comprises salicylic acid, especially in an amount within a range from 1 to 15 parts by weight, preferably 2 to 12 parts by weight, especially 3 to 10 parts by weight, per 100 parts by weight of the sum of IPDA and N-benzylethane-1,2-diamine. Such a curing agent permits a particularly nice surface when cured under cold conditions.

Most preferably, the curing agent comprises a combination of salicylic acid and 2,4,6-tris(dimethylaminomethyl)phenol. 2,4,6-Tris(dimethylaminomethyl)phenol is present here especially in an amount within a range from 1 to 15 parts by weight, preferably 2 to 12 parts by weight, especially 3 to 10 parts by weight, per 100 parts by weight of the sum of IPDA and N-benzylethane-1,2-diamine. Such a curing agent permits particularly rapid curing in combination with a particularly nice surface, especially when cured under cold conditions

Suitable thinners are especially xylene, 2-methoxyethanol, dimethoxyethanol, 2-ethoxyethanol, 2-propoxyethanol, 2-isopropoxyethanol, 2-butoxyethanol, 2-phenoxyethanol, 2-benzyloxyethanol, benzyl alcohol, ethylene glycol, ethylene glycol dimethyl ether, ethylene glycol diethyl ether, ethylene glycol dibutyl ether, ethylene glycol diphenyl ether, diethylene glycol, diethylene glycol monomethyl ether, diethylene glycol monoethyl ether, diethylene glycol mono-n-butyl ether, diethylene glycol dimethyl ether, diethylene glycol diethyl ether, diethylene glycol di-n-butyl ether, propylene glycol butyl ether, propylene glycol phenyl ether, dipropylene glycol, dipropylene glycol monomethyl ether, dipropylene glycol dimethyl ether, dipropylene glycol di-n-butyl ether, diphenylmethane, diisopropylnaphthalene, mineral oil fractions, for example Solvesso® grades (from Exxon), alkylphenols such as tert-butylphenol, nonylphenol, dodecylphenol, cardanol (from cashew nut shell oil, containing 3-(8,11-pentadecadienyl)phenol as its principal constituent), styrenized phenol, bisphenols, aromatic hydrocarbon resins, especially types containing phenol groups, alkoxylated phenol, especially ethoxylated or propoxylated phenol, especially 2-phenoxyethanol, adipates, sebacates, phthalates, benzoates, organic phosphoric or sulfonic esters or sulfonamides.

Preferred thinners have a boiling point of more than 200° C.

The thinner is preferably selected from the group consisting of benzyl alcohol, styrenized phenol, ethoxylated phenol, aromatic hydrocarbon resins containing phenol groups, especially the Novares® LS 500, LX 200, LA 300 or LA 700 products (from Rutgers), diisopropylnaphthalene and cardanol.

Particular preference is given to benzyl alcohol.

Thinners containing phenol groups are also effective as accelerator.

The curing agent may comprise further constituents, especially the following:
monoamines such as in particular benzylamine or furfurylamine;
polyamidoamines, especially reaction products of a mono- or polybasic carboxylic acid, or the ester or anhydride thereof, especially a dimer fatty acid, with a polyamine used in stoichiometric excess, especially DETA or TETA;
Mannich bases, especially phenalkamines, i.e. reaction products of phenols, especially cardanol, with aldehydes, especially formaldehyde, and polyamines.
aromatic polyamines such as in particular 4,4′-, 2,4′ and/or 2,2′-diaminodiphenylmethane, 2,4- and/or 2,6-tolylenediamine, 3,5-dimethylthio-2,4-tolylenediamine and/or 3,5-dimethylthio-2,6-tolylenediamine, 3,5-diethyl-2,4-tolylenediamine and/or 3,5-diethyl-2,6-tolylenediamine;
compounds having mercapto groups, especially liquid mercaptan-terminated polysulfide polymers, mercaptan-terminated polyoxyalkylene ethers, mercaptan-terminated polyoxyalkylene derivatives, polyesters of thiocarboxylic acids, 2,4,6-trimercapto-1,3,5-triazine, triethylene glycol dimercaptan or ethanedithiol.

The curing agent preferably has only a low content of further amines.

In particular, at least 30%, preferably at least 40%, more preferably at least 50%, in particular at least 60%, of all the amine hydrogens present in the curing agent originate from N-benzylethane-1,2-diamine and IPDA. Such a curing agent permits an attractive combination of rapid curing, little tendency to blushing effects, high hardness, and high glass transition temperature.

The curing agent preferably has only a low amount of thinners, more particularly 0% to 50% by weight, preferably 0% to 30% by weight, of thinners, especially benzyl alcohol.

The curing agent of the invention is preferably not water-based. It especially contains less than 15% by weight, preferably less than 10% by weight, of water. Such a curing agent is suitable for nonaqueous epoxy resin products, especially floor coatings.

The present invention further provides an epoxy resin composition comprising
a resin component comprising at least one epoxy resin and
a curing agent component comprising the curing agent of the invention.

A suitable epoxy resin is obtained in a known manner especially from the reaction of epichlorohydrin with polyols, polyphenols or amines.

Suitable epoxy resins are especially aromatic epoxy resins, especially the glycidyl ethers of:
bisphenol A, bisphenol F or bisphenol A/F, where A stands for acetone and F for formaldehyde used as reactants in the production of these bisphenols. In the case of bisphenol F, positional isomers may also be present, more particularly ones derived from 2,4′- or 2,2′-hydroxyphenylmethane.
dihydroxybenzene derivatives such as resorcinol, hydroquinone or catechol;
further bisphenols or polyphenols such as bis(4-hydroxy-3-methylphenyl)methane, 2,2-bis(4-hydroxy-3-methylphenyl)propane (bisphenol C), bis(3,5-dimethyl-4-hydroxyphenyl)methane, 2,2-bis(3,5-dimethyl-4-hydroxyphenyl)propane, 2,2-bis(3,5-dibromo-4-hydroxyphenyl)propane, 2,2-bis(4-hydroxy-3-tert-butylphenyl)propane, 2,2-bis(4-hydroxyphenyl)butane (bisphenol B), 3,3-bis(4-hydroxyphenyl)pentane, 3,4-bis(4-hydroxyphenyl)hexane, 4,4-bis(4-hydroxyphenyl)heptane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane (bisphenol Z), 1,1-bis(4-hydroxyphenyl)-3,3,5-trimethylcyclohexane (bisphenol TMC), 1,1-bis(4-hydroxyphenyl)-1-phenylethane, 1,4-bis[2-(4-hydroxyphenyI)-2-propyl]benzene (bisphenol P), 1,3-bis[2-(4-hydroxyphenyI)-2-propyl]benzene (bisphenol M), 4,4′-dihydroxydiphenyl (DOD), 4,4′-dihydroxybenzophenone, bis(2-hydroxynaphth-1-yl)methane, bis(4-hydroxynaphth-1-yl)methane, 1,5-dihydroxynaphthalene, tris(4-hydroxyphenyl)methane, 1,1,2,2-tetrakis(4-hydroxyphenyl)ethane, bis(4-hydroxyphenyl) ether or bis(4-hydroxyphenyl) sulfone;
novolaks, which are especially condensation products of phenol or cresols with formaldehyde or paraformaldehyde or acetaldehyde or crotonaldehyde or isobutyraldehyde or 2-ethylhexanal or benzaldehyde or furfural;
aromatic amines such as aniline, toluidine, 4-aminophenol, 4,4′-methylenediphenyldiamine, 4,4′-methylenediphenyldi(N-methyl)amine, 4,4′-[1,4-phenylenebis(1-methylethylidene)]bisaniline (bisaniline P) or 4,4′-[1,3-phenylenebis(1-methylethylidene)]bisaniline (bisaniline M).

Further suitable epoxy resins are aliphatic or cycloaliphatic polyepoxides, especially
glycidyl ethers of saturated or unsaturated, branched or unbranched, cyclic or open-chain di-, tri- or tetrafunctional C₂ to C₃₀ alcohols, especially ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
a hydrogenated bisphenol A, F or A/F liquid resin or the glycidylation products of hydrogenated bisphenol A, F or A/F;
an N-glycidyl derivative of amides or heterocyclic nitrogen bases, such as triglycidyl cyanurate or triglycidyl isocyanurate, or reaction products of epichlorohydrin with hydantoin.

The epoxy resin is preferably a liquid resin or a mixture comprising two or more liquid epoxy resins.

“Liquid epoxy resin” refers to an industrial polyepoxide having a glass transition temperature below 25° C.

The resin component optionally additionally contains proportions of solid epoxy resin.

The epoxy resin is especially a liquid resin based on a bisphenol, especially a bisphenol A diglycidyl ether and/or bisphenol F diglycidyl ether, as are commercially available for example from Olin, Huntsman or Momentive. These liquid resins have a low viscosity for epoxy resins and permit rapid curing and high hardnesses. They may comprise proportions of solid bisphenol A resin or novolak glycidyl ethers.

The resin component may comprise a reactive diluent.

Preferred reactive diluents are reactive diluents containing epoxy groups, especially butanediol diglycidyl ether, hexanediol diglycidyl ether, trimethylolpropane di- or triglycidyl ether, phenyl glycidyl ether, cresyl glycidyl ether, guaiacol glycidyl ether, 4-methoxyphenyl glycidyl ether, p-n-butylphenyl glycidyl ether, p-tert-butylphenyl glycidyl ether, 4-nonylphenyl glycidyl ether, 4-dodecylphenyl glycidyl ether, cardanol glycidyl ether, benzyl glycidyl ether, allyl glycidyl ether, butyl glycidyl ether, hexyl glycidyl ether, 2-ethylhexyl glycidyl ether, or glycidyl ethers of natural alcohols, such as in particular C₈ to C₁₀ or C₁₂ to C₁₄ or C₁₃ to C₁₅ alkyl glycidyl ethers.

The epoxy resin composition preferably comprises at least one further constituent selected from the group consisting of thinners, accelerators and fillers.

Suitable accelerators are those already mentioned, especially salicylic acid, calcium nitrate or 2,4,6-tris(dimethylaminomethyl)phenol or a combination thereof. Particular preference is given to salicylic acid, especially in combination with 2,4,6-tris(dimethylaminomethyl)phenol.

Suitable thinners are those already mentioned, especially those having a boiling point of more than 200° C.

The thinner is preferably selected from the group consisting of benzyl alcohol, styrenized phenol, ethoxylated phenol, aromatic hydrocarbon resins containing phenol groups, especially the Novares® LS 500, LX 200, LA 300 or LA 700 products (from Rütgers), diisopropylnaphthalene and cardanol.

Particular preference is given to benzyl alcohol.

Suitable fillers are, in particular, ground or precipitated calcium carbonate, which is optionally coated with fatty acid, especially stearates, baryte (heavy spar), talc, quartz flour, quartz sand, silicon carbide, iron mica, dolomite, wollastonite, kaolin, mica (potassium aluminum silicate), molecular sieve, aluminum oxide, aluminum hydroxide, magnesium hydroxide, silica, cement, gypsum, fly ash, carbon black, graphite, metal powders such as aluminum, copper, iron, zinc, silver or steel, PVC powder or hollow beads.

Preference is given to calcium carbonate, quartz flour, quartz sand or a combination thereof.

The epoxy resin composition optionally comprises further auxiliaries and additives, especially the following:
reactive diluents, especially those already mentioned, or epoxidized soybean oil or linseed oil, compounds containing acetoacetate groups, especially acetoacetylated polyols, butyrolactone, carbonates, aldehydes, isocyanates or silicones having reactive groups;
polymers, especially polyamides, polysulfides, polyvinyl formal (PVF), polyvinyl butyral (PVB), polyurethanes (PUR), polymers having carboxyl groups, polyamides, butadiene-acrylonitrile copolymers, styrene-acrylonitrile copolymers, butadiene-styrene copolymers, homo- or copolymers of unsaturated monomers, especially from the group comprising ethylene, propylene, butylene, isobutylene, isoprene, vinyl acetate or alkyl (meth)acrylates, especially chlorosulfonated polyethylenes or fluorine-containing polymers or sulfonamide-modified melamines;
fibers, especially glass fibers, carbon fibers, metal fibers, ceramic fibers or polymer fibers such as polyamide fibers or polyethylene fibers;
pigments, especially titanium dioxide, iron oxides or chromium(III) oxide;
rheology modifiers, especially thickeners or antisettling agents;
adhesion improvers, especially organoalkoxysilanes;
flame-retardant substances, especially the aluminum hydroxide or magnesium hydroxide fillers already mentioned, antimony trioxide, antimony pentoxide, boric acid (B(OH)₃), zinc borate, zinc phosphate, melamine borate, melamine cyanurate, ammonium polyphosphate, melamine phosphate, melamine pyrophosphate, polybrominated diphenyl oxides or diphenyl ethers, phosphates such as in particular diphenyl cresyl phosphate, resorcinol bis(diphenyl phosphate), resorcinol diphosphate oligomer, tetraphenylresorcinol diphosphite, ethylenediamine diphosphate, bisphenol A bis(diphenyl phosphate), tris(chloroethyl) phosphate, tris(chloropropyl) phosphate, tris(dichloroisopropyl) phosphate, tris[3-bromo-2,2-bis(bromomethyl)propyl] phosphate, tetrabromobisphenol A, bis(2,3-dibromopropyl ether) of bisphenol A, brominated epoxy resins, ethylenebis(tetrabromophthalimide), ethylenebis(dibromonorbornanedicarboximide), 1,2-bis(tribromophenoxy)ethane, tris(2,3-dibromopropyl) isocyanurate, tribromophenol, hexabromocyclododecane, bis(hexachlorocyclopentadieno)cyclooctane or chloroparaffins; or
additives, especially dispersed paraffin wax, film-forming auxiliaries, wetting agents, leveling agents, defoamers, deaerators, stabilizers against oxidation, heat, light or UV radiation, or biocides.

The epoxy resin composition preferably comprises further auxiliaries and additives, especially pigments, wetting agents, leveling agents and/or defoamers.

The epoxy resin composition preferably has only a low content of thinners. It preferably contains less than 20% by weight, more preferably less than 15% by weight, especially less than 10% by weight, of thinners. This permits low-emission or emission-free epoxy resin products.

The epoxy resin composition preferably has only a low content of water, preferably less than 5% by weight, in particular less than 1% by weight, of water.

In the epoxy resin composition, the ratio of the number of groups reactive toward epoxy groups relative to the number of epoxy groups is preferably within a range from 0.5 to 1.5, in particular 0.7 to 1.2.

The primary and secondary amino groups present in the epoxy resin composition, and any further groups present that are reactive toward epoxy groups, react with the epoxy groups, resulting in ring opening (addition reaction) thereof. As a result primarily of this reaction, the composition polymerizes and thereby cures.

The resin component and the curing agent component of the epoxy resin composition are stored in separate containers. Further constituents of the epoxy resin composition may be present as a constituent of the resin component or of the curing agent component; further constituents reactive toward epoxy groups are preferably a constituent of the curing agent component. It is likewise possible for further constituents to be present as a separate further component.

A suitable container for storage of the resin component or the curing agent component is especially a vat, a hobbock, a bag, a bucket, a can, a cartridge or a tube. The components are storable, meaning that they can be stored prior to use for several months up to one year or longer without any change in their respective properties to a degree relevant to their use. For the use of the epoxy resin composition, the components are mixed with one another shortly before or during application. The mixing ratio between the resin component and the curing agent component is preferably chosen such that the groups of the curing agent component that are reactive toward epoxy groups are in a suitable ratio to the epoxy groups of the resin component, as described above. In parts by weight, the mixing ratio between the resin component and the curing agent component is normally within a range from 1:10 to 10:1.

The components are mixed by means of a suitable method; this mixing may be done continuously or batchwise. If the mixing does not immediately precede the application, it must be ensured that not too much time passes between mixing the components and the application thereof and that application takes place within the pot life. Mixing takes place in particular at ambient temperature, which is typically within a range from about 5 to 40° C., preferably about 10 to 35° C.

Curing by chemical reaction begins with the mixing of the two components, as described above. Curing typically takes place at a temperature within a range from 0 to 150° C. It preferably takes place at ambient temperature and typically extends over a period of a few days to weeks. The duration depends on factors including the temperature, the reactivity of the constituents, and the stoichiometry thereof, and on the presence of accelerators.

When freshly mixed, the epoxy resin composition has low viscosity. The viscosity at 20° C. 10 minutes after the resin component and curing agent component have been mixed is preferably within a range from 100 to 4000 mPa·s, preferably 200 to 3000 mPa·s, more preferably 200 to 2000 mPa·s, in particular 200 to 1500 mPa·s, measured using a cone-plate viscometer at a shear rate of 10 s⁻¹.

When cured under cold conditions at 8° C. and 80% relative humidity, the Shore D hardness after 24 hours is preferably at least 11. This is achieved in particular with a curing agent in which the ratio of the number of amine hydrogens from IPDA and N-benzylethane-1,2-diamine is within a range from 70/30 to 20/80 and that in particular additionally comprises salicylic acid.

The epoxy resin composition is applied to at least one substrate, the following substrates being particularly suitable:
glass, glass ceramic, concrete, mortar, cement screed, fiber cement, brick, tile, plaster or natural rocks such as granite or marble;
repair or leveling compounds based on PCC (polymer-modified cement mortar) or ECC (epoxy resin-modified cement mortar);
metals or alloys such as aluminum, iron, steel, copper, other nonferrous metals, including surface-upgraded metals or alloys such as galvanized or chrome-plated metals;
asphalt or bitumen;
leather, textiles, paper, wood, woodbase materials bonded with resins, e.g. phenolic, melamine or epoxy resins, resin-textile composites or further so-called polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFRP), glass fiber-reinforced plastics (GFRP) and sheet molding compounds (SMC);
insulation foams, especially made of EPS, XPS, PUR, PIR, rock wool, glass wool or foamed glass;
coated or painted substrates, especially painted tiles, coated concrete, powder-coated metals or alloys or painted metal sheets;
coatings, paints or varnishes, especially coated floors that have been overcoated with a further floor covering layer.

If required, the substrates can be pretreated prior to application, especially by physical and/or chemical cleaning methods or the application of an activator or a primer.

The curing of the epoxy resin composition affords a cured composition.

Once cured, the epoxy resin composition has a high glass transition temperature. Preferably, after a curing time of 14 days at room temperature, the glass transition temperature is during the first heating (first run) at least 45° C., preferably at least 50° C., and during the second heating (second run) at least 60° C., preferably at least 65° C., determined by DSC with a measurement program of (1) −10° C. for 2 min, (2) −10 to 200° C. at a heating rate of 10 K/min (=first run), (3) 200 to −10° C. at a cooling rate of −50 K/min, (4) −10° C. for 2 min, (5) −10 to 180° C. at a heating rate of 10 K/min (=second run).

The epoxy resin composition is preferably used as coating, primer, adhesive, sealant, potting compound, casting resin, impregnating resin or as matrix for fiber composites such as CFRP or GFRP in particular.

The epoxy resin composition is particularly preferably used as a coating. Coatings are understood here to mean coverings of all kinds that are applied over an area, especially floor coverings, paints, varnishes, sealants, basecoats, primers or protective coatings, especially also those for heavy-duty corrosion protection. The epoxy resin composition is particularly suitable as a floor covering or floor coating for interiors such as offices, industrial halls, sports halls or cold rooms, or outdoors for balconies, terraces, parking decks, bridges or roofs, as a protective coating for concrete, cement, metals, plastics or wood, for example for surface sealing of wood constructions, vehicles, loading areas, tanks, silos, shafts, pipelines, machines or steel constructions, for example of ships, piers, offshore platforms, lock gates, hydroelectric power plants, river constructions, swimming pools, wind turbines, bridges, chimneys, cranes or sheet-pile walls, or as an undercoat, tiecoat or anticorrosion primer or for hydrophobization of surfaces.

The epoxy resin composition is particularly advantageously used in low-emission coatings with environmental quality seals, for example in accordance with Emicode (EC1 Plus), AgBB, DIBt, Der Blaue Engel, AFSSET, RTS (M1) and US Green Building Council (LEED).

For use as a coating, the epoxy resin composition advantageously has a fluid consistency with low viscosity and good leveling properties. The mixed composition is typically applied, within its pot life, to the surface of a substrate as a thin film having a layer thickness of about 50 μm to about 5 mm, typically at ambient temperature. It is applied especially by pouring onto the substrate to be coated and then spreading it evenly using, for example, a doctor blade or a notched trowel. It may also be applied with a brush or roller or in the form of a spray application, for example as an anticorrosion coating on steel. Curing typically gives rise to substantially homogeneous, glossy and nontacky films of high hardness that have good adhesion to a wide variety of different substrates.

The invention thus further provides a method for coating, comprising the steps of

(i) mixing the components of the epoxy resin composition,

(ii) applying the mixed composition to a substrate within the pot life, followed by the curing of the mixed composition.

It is possible to apply a further coating to the fully or partly cured composition, in which case said further layer may likewise be an epoxy resin composition, or else another material, especially a polyurethane or polyurea coating.

Preference is also given to using the epoxy resin composition as an adhesive. When used as adhesive, the epoxy resin composition typically has, after the components have been mixed, a pasty consistency with structurally viscous properties. On application, the mixed adhesive is applied within the pot life to at least one of the substrates to be bonded and the two substrates are joined to form an adhesive bond within the open time of the adhesive.

The mixed adhesive is applied especially by means of a brush, roll, spatula, doctor blade or trowel, or from a tube, cartridge or metering device.

The adhesive is particularly suitable for uses in the construction industry, especially for the reinforcement of built structures by means of steel lamellas or lamellas made of carbon fiber-reinforced composite plastics (CFRP), for constructions containing bonded precast concrete components, especially bridges or concrete towers, for example for wind turbines, shafts, pipelines or tunnels, or for constructions containing bonded natural rocks, ceramic elements or parts made of fiber cement, steel, cast iron, aluminum, wood or polyester, for the anchoring of dowels or steel bars in boreholes, for the fixing of, for example, handrails, balustrades or door frames, for repairs such as in particular the filling of edges, holes or joins in concrete maintenance, or for the bonding of films of polyvinyl chloride (PVC), flexibilized polyolefin (Combiflex®) or adhesion-modified chlorosulfonated polyethylene (Hypalon®) to concrete or steel.

Further fields of use relate to structural bonding in the construction or manufacturing industry, especially as adhesive mortar, assembly adhesive, reinforcement adhesive such as, in particular, for the bonding of lamellas made of CFRP or steel to concrete, brickwork or wood, as element adhesive, for example for bridge elements, sandwich element adhesive, facade element adhesive, reinforcing adhesive, bodywork adhesive or half-shell adhesive for rotor blades of wind turbines.

Such an epoxy resin adhesive is likewise suitable for filling cavities such as gaps, cracks or drill holes, wherein the adhesive is filled or injected into the cavity and fills it after curing, and joins or bonds the flanks of the cavity to one another in a force-fitting manner.

The invention thus further provides a method for bonding, comprising the steps of

(i) mixing the components of the epoxy resin composition,

(ii) applying the mixed composition within the pot life,
either to at least one of the substrates to be bonded and joining the substrates to form a bond within the open time,
or into a cavity or gap between two or more substrates and optionally inserting an anchor into the cavity or gap within the open time,

followed by the curing of the mixed composition.

An “anchor” refers here more particularly to a rebar, a threaded rod or a bolt. Such an anchor is in particular adhesive-bonded or anchored in a wall, ceiling or foundation in such a way that a portion thereof is bonded in a force-fitting manner and a portion thereof protrudes and can be subjected to a construction load.

Identical or different substrates may be bonded.

The application and curing of the epoxy resin composition afford an article. The invention thus further provides an article obtained from the use of the epoxy resin composition.

The article is preferably a built structure or part thereof, especially a built structure above or below ground, an office, an industrial hall, a sports hall, a cold room, a silo, a bridge, a roof, a staircase, a floor, a balcony, a terrace or a parking deck, or an industrial item or a consumer item, especially a pier, an offshore platform, a lock gate, a crane, a sheet-pile wall, a pipeline or a rotor blade of a wind turbine, or a mode of transport such as in particular an automobile, a truck, a rail vehicle, a ship, an aircraft or a helicopter, or an installable component thereof.

The epoxy resin composition is characterized by advantageous properties. It has particularly low viscosity and thus excellent processability, and cures reliably and quickly, in particular even under damp and cold conditions, resulting in coatings of high mechanical quality having high hardness, a high glass transition temperature, nice surfaces, and surprisingly little tendency to yellowing. Such epoxy resin compositions are particularly suitable as coatings, especially for floors.

### EXAMPLES

Working examples are adduced hereinafter, which are intended to further elucidate the invention described. The invention is of course not limited to these described working examples.

“AHEW” stands for amine hydrogen equivalent weight.

“EEW” stands for epoxy equivalent weight.

“Standard climatic conditions” (“SCC”) refers to a temperature of 23±1° C. and a relative air humidity of 50±5%.

The chemicals used were unless otherwise stated from Sigma-Aldrich Chemie GmbH.

Description of the Measurement Methods:

The viscosity was measured on a thermostated Rheotec RC30 cone-plate viscometer (cone diameter 50 mm, cone angle 1°, cone tip-plate distance 0.05 mm, shear rate 10 s⁻¹).

The amine value was determined by titration (with 0.1N HClO₄ in acetic acid against crystal violet).

Substances and Abbreviations Used:
Araldite® GY 250: Bisphenol A diglycidyl ether, EEW 187 g/equiv. (from Huntsman)
Araldite® DY-E: Monoglycidyl ethers of C₁₂ to C₁₄ alcohols, EEW approx. 290 g/equiv. (from Huntsman)
IPDA: 1-Amino-3-aminomethyl-3,5,5-trimethylcyclohexane, AHEW 42.6 g/equiv. (Vestamin® IPD from Evonik)
B-EDA: N-Benzylethane-1,2-diamine, prepared as described below, 150.2 g/mol, AHEW 50 g/equiv.
BAC 1,3-Bis(aminomethyl)cyclohexane, AHEW 35.5 g/equiv. (from Mitsubishi Gas Chemical)
MXDA 1,3-Bis(aminomethyl)benzene, AHEW 34 g/equiv. (from Mitsubishi Gas Chemical)
TMD 2,2(4),4-Trimethylhexamethylenediamine, AHEW 39.6 g/equiv. (Vestamin® TMD from Evonik)
TEPA Tetraethylenepentamine, AHEW about 30 g/equiv. (technical grade, from Huntsman)
Ancamine® K54 2,4,6-Tris(dimethylaminomethyl)phenol (from Air Products)

N-Benzylethane-1,2-Diamine (B-EDA):

A round-bottomed flask was charged with 180.3 g (3 mol) of ethane-1,2-diamine under a nitrogen atmosphere at room temperature. A solution of 106.0 g (1 mol) of benzaldehyde in 1200 ml of isopropanol was slowly added dropwise while stirring well and stirring was continued for a further 2 hours. The reaction mixture was then hydrogenated in a continuous hydrogenation apparatus with a Pd/C fixed-bed catalyst at a hydrogen pressure of 80 bar, a temperature of 80° C., and a flow rate of 5 ml/min. To monitor the reaction, IR spectroscopy was used to check whether the imine band at approx. 1665 cm⁻¹ had disappeared. The hydrogenated solution was then concentrated on a rotary evaporator at 65° C., removing unreacted ethane-1,2-diamine, water, and isopropanol. The reaction mixture thus obtained was a clear, pale yellowish liquid having an amine value of 678 mg KOH/g and containing approx. 85% by weight of N-benzylethane-1,2-diamine (retention time 8.47-8.57 min), as determined by GC.

120 g of this reaction mixture was purified by distillation at 80° C. under reduced pressure, resulting in 75.1 g of distillate (N-benzylethane-1,2-diamine) being collected at a vapor temperature of 60 to 65° C. and 0.06 mbar. A colorless liquid having a viscosity of 8 mPa·s at 20° C., an amine value of 750 mg KOH/g and a purity, determined by GC, of >97% was obtained. This was used for the further examples.

Preparation of Curing Agents and Epoxy Resin Compositions:

### Examples 1 to 18

For each example, the ingredients of the resin component specified in Tables 1 to 3 were mixed in the specified amounts (in parts by weight) using a centrifugal mixer (SpeedMixer™ DAC 150, FlackTek Inc.) and stored with the exclusion of moisture.

The ingredients of the curing agent component specified in Tables 1 to 3 were likewise processed and stored.

The two components of each composition were then processed using the centrifugal mixer into a homogeneous liquid and this was tested immediately as follows:

10 minutes after mixing, the viscosity was measured at 20° C. (“Viscosity (10′)”). The gel time was determined in standard climatic conditions by agitating the mixed composition (25 g) with a spatula from time to time until it began to gel.

For determination of Shore D hardness in accordance with DIN 53505, two cylindrical test specimens (diameter 20 mm, thickness 5 mm) were in each case produced. One was stored under standard climatic conditions and the hardness measured after 1 day and after 2 days (1d SCC and 2d SCC); the other was stored at 8° C. and 80% relative humidity and the hardness measured after 1 day and after 2 days in the cold state (1d 8°/80% and 2d 8°/80%).

A first film coating was applied to a glass plate in a layer thickness of 500 μm, and this was stored/cured under standard climatic conditions. The König hardness (König pendulum hardness, measured in accordance with DIN EN ISO 1522) was determined on this film after 1 day (“König hardness (1d SCC)”), after 2 days (“König hardness (2d SCC)”), after 4 days (“König hardness (4d SCC)”), after 7 days (“König hardness (7d SCC)”), and after 14 days (“König hardness (14d SCC)”). After 14 days, the appearance of the film was assessed (designated “Appearance (SCC)” in the table). A film was described as “nice” if it had a glossy and nontacky surface with no structure. “Structure” refers to any kind of marking or pattern on the surface. A film with reduced gloss was referred to as “dull”.

A second film coating was applied to a glass plate in a layer thickness of 500 μm and this was immediately after application stored/cured for 7 days at 8° C. and 80% relative humidity and then for 2 weeks under standard climatic conditions. 24 hours after application, a polypropylene bottle top beneath which a damp sponge had been positioned was placed on the film. After a further 24 hours, the sponge and the bottle top were removed and positioned at a new point on the film, from which it was removed and repositioned after 24 hours, this being done a total of 4 times. The appearance of this film was then assessed (designated “Appearance (8°/80%)” in the tables) in the same way as described for Appearance (SCC). Also reported in each case here was the number and nature of visible marks that had formed in the film as a result of the damp sponge or the bottle top on top. The number of white discolored spots was reported as “blushing”. A faint white discolored spot was designated as “(1)”. A clear white discolored spot was designated as “1”. The designation “ring” was reported if a ring-shaped imprint was present due to sinking of the first bottle top placed 24 hours after application. Such a ring-shaped imprint indicates that the coating was not ready to be walked on. A very minimal ring-shaped imprint was designated as “(yes)”. A clear ring-shaped imprint was designated as “yes”. The König hardness was again determined on the films thus cured, in each case after 7 days at 8° C. and 80% relative humidity (“König hardness (7d 8°/80%)”) and then after a further 2 days under SCC (“König hardness (+2d SCC)”), 7 days under SCC (“König hardness (+7d SCC)”), and 14 d under SCC (“König hardness (+14d SCC)”).

The Tg (glass transition temperature) was determined by DSC on cured samples that had been stored under standard climatic conditions for 14 days using a Mettler Toledo DSC 3+ 700 instrument and the following measurement program: (1) −10° C. for 2 min, (2) −10 to 200° C. at a heating rate of 10 K/min (=1st run), (3) 200 to −10° C. at a cooling rate of −50 K/min, (4) −10° C. for 2 min, (5) −10 to 180° C. at a heating rate of 10 K/min (=2nd run).

As a measure of yellowing, the change in color after stressing in a weathering tester was determined. For this, a further film coating was applied to a glass plate in a layer thickness of 500 μm and this was stored/cured under standard climatic conditions for 2 weeks and then stressed for 72 hours at a temperature of 65° C. in a model Q-Sun Xenon Xe-1 weathering tester having a Q-SUN Daylight-Q optical filter and a xenon lamp having a light intensity of 0.51 W/m² at 340 nm (Q-Sun (72 h)). The difference in color ΔE of the stressed film versus the corresponding unstressed film was then determined using an NH310 colorimeter from Shenzen 3NH Technology Co. LTD equipped with silicon photoelectric diode detector, light source A, color space measurement interface CIE L*a*b*C*H*.

The results are reported in Tables 1 to 3.

The examples designated “(Ref.)” are comparative examples.

TABLE 1
Composition and properties of examples 1 to 7.

| Example | | 1 (Ref.) | 2 | 3 | 4 | 5 | 6 (Ref.) | 7 (Ref.) |
|---|---|---|---|---|---|---|---|---|
| Resin comp.: | | | | | | | | |
| Araldite ® GY 250: | | 167.2 | 167.2 | 167.2 | 167.2 | 167.2 | 167.2 | 167.2 |
| Araldite ® DY-E: | | 31.8 | 31.8 | 31.8 | 31.8 | 31.8 | 31.8 | 31.8 |
| Curing agent comp.: | | | | | | | | |
| IPDA | | 42.6 | 34.1 | 25.6 | 21.3 | 12.8 | 6.4 | — |
| B-EDA | | — | 10.0 | 20.0 | 25.0 | 35.0 | 42.5 | 50.0 |
| Benzyl alcohol | | 25.0 | 25.0 | 25.0 | 25.0 | 25.0 | 25.0 | 25.0 |
| Salicylic acid | | 2.0 | 2.0 | 2.0 | 2.0 | 2.0 | 2.0 | 2.0 |
| Ancamine ® K54 | | 2.0 | 2.0 | 2.0 | 2.0 | 2.0 | 2.0 | 2.0 |
| IPDA/B-EDA¹ | | 100/0 | 80/20 | 60/40 | 50/50 | 30/70 | 15/85 | 0/100 |
| Viscosity (10′) [Pa · s] | | 0.79 | 0.56 | 0.49 | 0.45 | 0.44 | 0.40 | 0.30 |
| Gel time (h:min) | | 4:00 | 4:05 | 4:00 | 4:00 | 4:10 | 3:51 | 3:53 |
| Shore D | (1 d SCC) | 69 | 59 | 58 | 61 | 56 | 58 | 51 |
| | (2 d SCC) | 75 | 72 | 72 | 71 | 66 | 68 | 56 |
| Shore D | (1 d 8°/80%) | 9 | 8 | 11 | 13 | 14 | 15 | 18 |
| | (2 d 8°/80%) | 63 | 45 | 59 | 65 | 66 | 62 | 66 |
| König h. | (1 d SC [symbol] | 74 | 46 | 34 | 27 | 29 | 21 | 14 |
| [s] | (2 d SC [symbol] | 140 | 115 | 91 | 73 | 48 | 36 | 24 |
| | (4 d SC [symbol] | 167 | 148 | 137 | 120 | 81 | 64 | 28 |
| | (7 d SC [symbol] | 175 | 161 | 151 | 139 | 101 | 77 | 31 |
| | (14 d SC [symbol] | 177 | 165 | 160 | 157 | 116 | 83 | 31 |
| Appearance (SCC) | | nice | nice | nice | nice | nice | nice | nice |
| Tg 1st/2nd run [° C.] | | 57/87 | 54/79 | 50/73 | 47/66 | 46/60 | 42/53 | 40/50 |
| Q-Sun (72 h) ΔE | | 16.8 | 12.7 | 9.7 | 10.7 | 11.4 | 13.0 | 12.9 |
| König h. | (7 d 8°/80 [symbol] | 70 | 46 | 25 | 25 | 11 | 10 | 8 |
| [s] | (+2 d SC [symbol] | 150 | 134 | 123 | 88 | 57 | 32 | 22 |
| | (+7 d SC [symbol] | 171 | 157 | 155 | 109 | 69 | 67 | 41 |
| | (+14 d SC [symbol] | 172 | 175 | 161 | 139 | 88 | 68 | 41 |

| | | | | | | | |
|---|---|---|---|---|---|---|---|
| Appearance | dull | nice | nice | nice | nice | nice | nice |
| (8°/80%) | (1) | (1) | (1) | (1) | (1) | (1) | (1) |
| Blushing Ring | yes | (yes) | none | none | none | none | none |

¹Ratio of amine hydrogen equivalents from IPDA and B-EDA [symbol]
indicates data missing or illegible when filed

TABLE 2
Composition and properties of examples 8 to 11.

| Example | | 8 (Ref.) | 9 (Ref.) | 10 (Ref.) | 11 (Ref.) |
|---|---|---|---|---|---|
| Resin comp.: | | | | | |
| Araldite ® GY 250: | | 167.2 | 167.2 | 167.2 | 167.2 |
| Araldite ® DY-E: | | 31.8 | 31.8 | 31.8 | 31.8 |
| Curing agent comp.: | | | | | |
| Further amine | | BAC | MXDA | TMD | TEPA |
| | | 17.8 | 17.0 | 19.9 | 15.0 |
| B-EDA | | 25.0 | 25.0 | 25.0 | 25.0 |
| Benzyl alcohol | | 25.0 | 25.0 | 25.0 | 25.0 |
| Salicylic acid | | 2.0 | 2.0 | 2.0 | 2.0 |
| Ancamine ® K54 | | 2.0 | 2.0 | 2.0 | 2.0 |
| Viscosity (10′) [Pa·s] | | 0.42 | 0.36 | 0.35 | 0.48 |
| Gel time (h:min) | | 3:00 | 3:30 | 3:30 | 3:35 |
| Shore D | (1 d SCC) | 70 | 70 | 63 | 68 |
| | (2 d SCC) | 72 | 74 | 71 | 75 |
| Shore D | (1 d 8°/80%) | 48 | 44 | 28 | 27 |
| | (2 d 8°/80%) | 74 | 77 | 72 | 76 |
| König h. | (1 d SC [symbol] | 38 | 16 | 12 | 13 |
| [s] | (2 d SC [symbol] | 73 | 36 | 35 | 28 |
| | (7 d SC [symbol] | 99 | 62 | 76 | 63 |
| | (14 d SC [symbol] | 123 | 94 | 85 | 84 |
| Appearance (SCC) | | nice | slight | nice | slight |
| | | | structure | | structure |
| Tg 1st/2nd run [° C.] | | 41/60 | 41/51 | 40/57 | 44/51 |
| Q-Sun (72 h) ΔE | | 14.2 | 13.4 | 13.6 | 16.9 |
| König h. | (7 d 8°/80 [symbol] | 14 | 10 | 8 | 4 |
| [s] | (+2 d SC [symbol] | 56 | 24 | 38 | 7 |
| | (+7 d SC [symbol] | 83 | 45 | 52 | 18 |
| | (+14 d SC [symbol] | n.d. | n.d. | n.d. | n.d. |

| | | | | |
|---|---|---|---|---|
| Appearance (8°/80%) | slight haze | haze, structure | nice | haze, tacky |
| Blushing | 0 | 4 | 0 | 4 |
| Ring | none | none | (yes) | yes |

[symbol]

indicates data missing or illegible when filed

TABLE 3
Composition and properties of examples 12 to 18.

| Example | | 12 | 13 | 14 | 15 | 16 | 17 | 18 |
|---|---|---|---|---|---|---|---|---|
| Resin component: | | | | | | | | |
| Araldite ® GY 250: | | 167.2 | 167.2 | 167.2 | 167.2 | 167.2 | 167.2 | 167.2 |
| Araldite ® DY-E: | | 31.8 | 31.8 | 31.8 | 31.8 | 31.8 | 31.8 | 31.8 |
| Curing agent component: | | | | | | | | |
| IPDA | | 21.3 | 21.3 | 21.3 | 21.3 | 21.3 | 21.3 | 25.6 |
| B-EDA | | 25.0 | 25.0 | 25.0 | 25.0 | 25.0 | 25.0 | 20.0 |
| Benzyl alcohol | | 25.0 | 25.0 | 25.0 | 25.0 | 25.0 | 25.0 | 25.0 |
| Salicylic acid | | 2.0 | — | 2.0 | — | 4.0 | 4.0 | 2.0 |
| Ancamine ® K54 | | 2.0 | 2.0 | — | 4.0 | — | 4.0 | 4.0 |
| IPDA/B-EDA¹ | | 50/50 | 50/50 | 50/50 | 50/50 | 50/50 | 50/50 | 60/40 |
| Viscosity (10′) [Pa · s] | | 0.39 | 0.26 | 0.34 | 0.23 | 0.49 | 0.59 | 0.49 |
| Gel time (h:min) | | 4:00 | 4:30 | 3:30 | 3:50 | 3:00 | 2:25 | 3:20 |
| Shore D | (1 d SCC) | 68 | 69 | 58 | 74 | 62 | 72 | 68 |
| | (2 d SCC) | 75 | 78 | 73 | 79 | 73 | 77 | 71 |
| Shore D | (1 d 8°/80%) | 17 | 10 | 14 | 24 | 30 | 41 | 37 |
| | (2 d 8°/80%) | 61 | 61 | 20 | 39 | 65 | 63 | 70 |
| König h. | (1 d SC [symbol] | 36 | 32 | 25 | 53 | 22 | 52 | 63 |
| [s] | (2 d SC [symbol] | 77 | 84 | 63 | 108 | 59 | 94 | 116 |
| | (7 d SC [symbol] | 137 | 129 | 111 | 153 | 119 | 146 | 162 |
| | (14 d SC [symbol] | 155 | 151 | 146 | 167 | 143 | 160 | 169 |
| Appearance (SCC) | | nice | nice | nice | nice | nice | nice | nice |
| König h. | (7 d 8°/80 [symbol] | 25 | 25 | 13 | 34 | 17 | 29 | 41 |
| [s] | (+2 d SC [symbol] | 66 | 84 | 39 | 78 | 77 | 105 | 114 |
| | (+7 d SC [symbol] | 132 | 132 | 87 | 146 | 105 | 141 | 167 |
| | (+14 d SC [symbol] | 133 | 144 | 127 | 150 | 140 | 147 | 168 |

| | | | | | | | |
|---|---|---|---|---|---|---|---|
| Appearance | nice | nice | nice | slight haze | nice | nice | nice |
| (8°/80%) | (1) | 1 | (1) | 1 | (1) | (1) | (1) |
| Blushing Ring | none | none | yes | none | yes | none | none |

¹Ratio of amine hydrogen equivalents from IPDA and B-EDA [symbol]
indicates data missing or illegible when filed

### Examples 19 to 21

For these examples, a filled, commercial resin component was used in the amount shown in Table 4: Sikafloor®-264N component A RAL 5005 (from Sika).

The ingredients of the curing agent component shown in Table 4 were processed and stored as described above. The two components were then processed as described above into a homogeneous liquid and tested as specified for example 1. The results are reported in Table 4.

TABLE 4
Composition and properties of examples 19 to 21.

| Example | | 19 | 20 | 21 |
|---|---|---|---|---|
| Resin component: | | | | |
| Sikafloor ®-264N | | 436.0 | 436.0 | 436.0 |
| Component A | | | | |
| Curing agent component: | | | | |
| IPDA | | 25.6 | 29.8 | 29.8 |
| B-EDA | | 20.0 | 15.0 | 10.0 |
| BAC | | — | — | 7.1 |
| Benzyl alcohol | | 25.0 | 35.0 | 35.0 |
| Salicylic acid | | 2.0 | 2.0 | 2.0 |
| Ancamine ® K54 | | 4.0 | 4.0 | 4.0 |
| IPDA/B-EDA¹ | | 60/40 | 70/30 | 75/25 |
| Viscosity (10′) [Pa·s] | | 2.7 | 2.4 | 3.0 |
| Gel time (h:min) | | 2:50 | 3:15 | 2:45 |
| Shore D | (1 d SCC) | 68 | 59 | 66 |
| | (2 d SCC) | 73 | 69 | 73 |
| Shore D | (1 d 8°/80%) | 48 | 24 | 40 |
| | (2 d 8°/80%) | 74 | 62 | 65 |
| König h. | (1 d SCC) | 52 | 25 | 34 |
| [s] | (2 d SCC) | 97 | 57 | 69 |
| | (7 d SCC) | 148 | 120 | 119 |
| | (14 d SCC) | 148 | 133 | 125 |
| Appearance (SCC) | | nice | nice | nice |
| Q-Sun (72 h) ΔE | | 6.0 | 7.3 | 5.6 |
| König h. | (7 d 8°/80%) | 11 | 17 | 24 |
| [s] | (+2 d SCC) | 83 | 62 | 64 |
| | (+7 d SCC) | 98 | 81 | 83 |
| | (+14 d SCC) | 111 | 88 | 92 |

| | | | |
|---|---|---|---|
| Appearance (8°/80%) | nice | nice | nice |
| Blushing | (1) | (1) | 3 |
| Ring | none | none | none |

¹Ratio of amine hydrogen equivalents from IPDA and B-EDA

1. A curing agent for epoxy resins, comprising 1-amino-3-aminomethyl-3,5,5-trimethylcyclohexane and N-benzylethane-1,2-diamine in such an amount that the ratio of the number of amine hydrogens therein is within a range from 90/10 to 20/80.

2. The curing agent as claimed in claim 1, wherein less than 10% by weight, weight of 1-amino-3-aminomethyl-3,5,5-trimethylcyclohexane adducted with epoxy resin is present.

3. The curing agent as claimed in claim 1, wherein N-benzylethane-1,2-diamine has a purity of at least 80% by weight.

4. The curing agent as claimed in claim 1, wherein less than 10% by weight of N-benzylethane-1,2-diamine adducted with epoxy resin is present.

5. The curing agent as claimed in claim 1, wherein the ratio of the number of amine hydrogens from 1-amino-3-aminomethyl-3,5,5-trimethylcyclohexane and N-benzylethane-1,2-diamine is within a range from 80/20 to 25/75.

6. The curing agent as claimed in claim 1, wherein at least one further constituent selected from the group consisting of further amines, accelerators, and thinners is present.

7. The curing agent as claimed in claim 1, wherein at least 30% of all the amine hydrogens present in the curing agent originate from 1-amino-3-aminomethyl-3,5,5-trimethylcyclohexane and N-benzylethane-1,2-diamine.

8. The curing agent as claimed in claim 1, wherein it contains salicylic acid.

9. An epoxy resin composition comprising
a resin component comprising at least one epoxy resin and
a curing agent component comprising the curing agent as claimed in claim 1.

10. The epoxy resin composition as claimed in claim 9, wherein, 10 minutes after the resin component and curing agent component have been mixed, it has a viscosity at 20° C. within a range from 100 to 4000 mPa·s, measured using a cone-plate viscometer at a shear rate of 10 s⁻¹.

11. The epoxy resin composition as claimed in claim 9, wherein after the components have been mixed and after a curing time of 14 days at room temperature, it has a glass transition temperature during the first heating (first run) of at least 45° C., and during the second heating (second run) of at least 60° C., determined by DSC with a measurement program of (1) −10° C. for 2 min, (2) −10 to 200° C. at a heating rate of 10 K/min (=first run), (3) 200 to −10° C. at a cooling rate of −50 K/min, (4) −10° C. for 2 min, (5) −10 to 180° C. at a heating rate of 10 K/min (=second run).

12. A method comprising: applying the epoxy resin composition as claimed in claim 9 to a substrate, wherein the epoxy resin composition is applied to the substrate as a coating, primer, adhesive, sealant, potting compound, casting resin, impregnating resin or as matrix.

13. A method for coating, comprising the steps of
(i) mixing the components of the epoxy resin composition as claimed in claim 9,
(ii) applying the mixed composition to a substrate within the pot life,
followed by the curing of the mixed composition.

14. A method for bonding, comprising the steps of
(i) mixing the components of the epoxy resin composition as claimed in claim 9,
(ii) applying the mixed composition within the pot life,
either to at least one of the substrates to be bonded and joining the substrates to form a bond within the open time,
or into a cavity or gap between two or more substrates and optionally inserting an anchor into the cavity or gap within the open time,
followed by the curing of the mixed composition.

15. An article obtained from the method as claimed in claim 12.

16. An article obtained from the method as claimed in claim 13.

17. An article obtained from the method as claimed in claim 14.
